(19) United States
(12) Patent Application Publication
(10) Pub. No.: US 2005/0100645 A1
(43) Pub. Date: May 12, 2005

(54) Process for producing vegetable foods from coconuts

(76) Inventor: Werner Baensch, Holzminden (DE)

Correspondence Address: MCGLEW & TUTTLE, PC, 1 SCARBOROUGH STATION PLAZA, SCARBOROUGH, NY, 10510-0827, US

(21) Appl. No.: 10/975,777

(22) Filed: Oct. 28, 2004

(30) Foreign Application Priority Data
Nov. 11, 2003 (DE) DE 103 52 583.1
Apr. 16, 2004 (DE) DE 10 04 026 729.

(51) Int. Cl. A23P 1/00

(52) U.S. Cl. 426/482

(57) ABSTRACT

A process is provided for isolating vegetable foods from coconuts, which essentially consists of the gentle isolation of coconut rasps and their pulverization, whereby a low-fat, dry pressed cake forms, whose particle size is <150 μm. By means of fermenting this pressed cake by mashing with water and adding enzyme preparations to it, the fibers can biochemically degrade into digestible foods, so that the physiologically more highly nutritious parts of the coconut, namely proteins, carbohydrates, vitamins and minerals are made completely accessible for human nutrition. By homogenization and spray drying, the pulp produced by fermentation can be converted into a coconut meal. This coconut meal may be further processed into vegetarian foods.

### CROSS REFERENCE TO RELATED APPLICATIONS

This application claims the benefit of priority under 35 U.S.C. § 119 of DE 103 52 583.1 of Nov. 11, 2003 and DE 10 2004 026 729.4 filed Apr. 16, 2004, the entire contents of each are incorporated herein by reference.

### FIELD OF THE INVENTION

The present invention pertains to a process for producing vegetable foods from coconuts.

### BACKGROUND OF THE INVENTION

In the current processing of coconuts, special importance is placed on isolating the oil, whereby the pressed cake produced in the course of the isolation of the oil is still used as animal feed, if necessary.

For this, a method is used in the producer countries, in which coconut meat is mechanically isolated from the coconut and this coconut meat is spread out and thus dried for several days in the sun or on heated drying ovens. A so-called “copra” forms, which is pressed out by means of large screw presses. A pressing temperature of markedly above 100° C., usually 130-160° C., is reached with this pressing process—associated with the design. These high pressing temperatures lead to the proteins and carbohydrates caramelizing and as a result they become worthless for human nutrition. Therefore, as was already mentioned, this pressed cake is best used as animal feed. The pressed cakes turn dark brown due to the “baking” temperatures used during the pressing, which indicate the formation of melanoidins and acrylamides. In this way, the most valuable contents of the coconut, namely protein and sugar, are lost for human nutrition.

Moreover, the meat of coconut contains up to 38% natural fibers. The fibers consist of cellulose and hemicellulose, which can be equated to wood, which is unsuitable for human nutrition because it is indigestible.

A process for producing coconut flakes and products obtained therefrom has become known from DE 24 22 640 A1. Essentially what was stated beforehand is confirmed in the reported state of the art. The object of this patent application was to develop a process, which, in addition to creating the coconut oil, also makes it possible to use the remaining parts. Even though an end product, namely coconut flakes, are described there, among other things, no indications are made, however, for the further processing of this product into vegetable foods.

Rather, in the processing process, it is indicated that the nuts with coconut milk removed are placed into an autoclave and are then subjected to a vapor pressure of 1.5 kg/cm² for 8 hours. Already this indication shows that high temperatures are used in this processing, and it may be readily assumed that, as a result of this, such great heat damage or destruction of the natural vegetable proteins and carbohydrates present in the pressed cake is caused that these are lost for human nutrition.

### SUMMARY OF THE INVENTION

Consequently, the object of the present invention is to provide a production process for producing vegetable food from coconuts, which, in addition to the isolation of the oil, makes almost all of the remaining parts accessible for human nutrition, while retaining the proteins and carbohydrates.

According to the invention, a process is provided for producing vegetable foods from coconuts. The process includes isolating coconut rasps from preferably fresh coconut meat that has been removed from the coconut shell and their drying at less than 100° C. The coconut oil and a low-fat pressed cake containing ca. 5% residual moisture are isolated by pressing the coconut rasps within a temperature range between 40° C. and 60° C. The low-fat pressed cake is pulverized to particle sizes of less than 150 μm at a maximum pulverization temperature of 80° C. The pulverized pressed cake is fermented by mashing with water to create a pumpable pulp, to which is added an enzyme preparation composed of various types of enzymes. The coconut meal is isolated by means of homogenization, pasteurization and spray drying of the mash fermented with enzymes and is further processed into vegetable products.

The mashing may be carried out by stirring in five parts water to one part pressed cake.

The enzyme types of the enzyme preparations may consist of a mixture of preferably cellulase, beta-glucanase and hemicellulase preparations.

Optimal fermentation conditions may be set by means of controlling the time and temperature effects as well as the degree of acidity of the mash. The fermentation time may advantageously run for 12 hours at a temperature of 42° C. and the initial degree of acidity of the mash may be lowered from ca. pH 6.5 to pH 4.0-5.5. The lowering of the degree of acidity of the mash may be by adding mono- and disaccharides (sugar) or by adding citric acid. The homogenization of the fermented acid may take place at a pressure of 200-300 bar and the spray drying may take place according to the vacuum spray drying process.

The various features of novelty which characterize the invention are pointed out with particularity in the claims annexed to and forming a part of this disclosure. For a better understanding of the invention, its operating advantages and specific objects attained by its uses, reference is made to the accompanying descriptive matter in which preferred embodiments of the invention are illustrated.

### DESCRIPTION OF THE PREFERRED EMBODIMENTS

This novel production process shall be described by way of example based on the representation of a procedure:

The white coconut meat scraped out of fresh coconuts is dried in a fluidized bed at gentle temperatures of less than 100° C. Coconut rasps form. Coconut rasps are also known on the market by the English term “desiccated coconut.” These have a residual moisture of less than 5%.

These coconut rasps are then pressed by means of a press, whereby the coconut oil contained in the coconut rasps is isolated in a low temperature range between 40° C. and 60° C. maximum and then the coconut rasps are pressed out to a residual oil content of ca. 10%. The coconut oil is then fed to further processing and use, known per se. The by-product remaining behind in this pressing procedure is a light, white pressed cake, which is used for further production of vegetable, dietary products. Thus, it is a starting product for the procedure described further below:

The processing includes a pulverization of the low-fat pressed cake to below a particle size of <150 μm. In this pulverizing process, the friction heat may by no means exceed 80° C., since, otherwise, the vegetable proteins coagulate, i.e., they become unusable for human nutrition.

In order to make the fibers contained in the pressed cake accessible for human use, this fat-reduced, dry, pressed cake is fermented and mashed by adding water, whereby enzyme preparations, which consist of various types of enzymes, are additionally added. These may primarily be mixtures of cellulase, beta-glucanase and hemicellulase preparations. In practice, commercially available preparations, such as Alphamalt HC 6043, HC 12042, T 12031, as well as Depol 333P and Cellulase 13P were successfully used for the enzymatic degradation of the fibers. Especially at a dose of 15-20 g to 100 kg of mash, these enzyme preparations brought about a sufficient degradation of the cellulose-containing fibers.

In the further processing, it is critically important for the fermentation conditions to be optimized, in that, in terms of the time, the fermentation run is limited to 12 hours at an optimum temperature of 42° C. By adding a) lactic acid-forming starter cultures or b) citric acid, the initial degree of acidity of the mash may be lowered from pH 6.5 to a pH of 4.0-5.5, which is favorable for the enzymatic degradation of the fibers.

Application a) results in a mildly sour mash with a characteristic flavor of cheese, while application b) results in the typical sweet flavor of coconut.

The further processing provides for the homogenization, pasteurization, as well as spray drying of the fermented mash, which means that, after the fermentation has been carried out, the fibers are so degraded by the enzymes that these fibers are split up into such small fragments by completing the homogenization at a pressure of 200-300 bar that they are no longer detectable to the senses. This is then followed by a pasteurization and vacuum spray drying of the mash.

Thus, this process results in a coconut meal, whose higher content of natural, physiologically highly nutritious constituents are very suitable for the further processing and production of the widest variety of foods. It has a high water-binding ability and is therefore especially suitable for the production and use of or in dietary creams, sauces, dips, spreads, desserts, sweets, yogurt, fruit and (coconut) milk drinks and baked goods.

Due to the processing by fermentation, it is especially cholesterol-free, gluten-free, lactose-free, rich in highly nutritious vegetable proteins (amino acids) and natural roughage.

Due to this novel processing of coconuts a novel, highly promising type of nutrient supply presents itself particularly in the producer countries, so that this process is of especially great economic importance.

While an example of the invention has been described in detail to illustrate the application of the principles of the invention, it will be understood that the invention may be practiced otherwise without departing from such principles.

1. A process for producing vegetable foods from coconuts, the process comprising the following process steps:
isolating coconut rasps from fresh coconut meat removed from the coconut shell and then dried at less than 100° C.;
isolating coconut oil and a low-fat pressed cake containing ca. 5% residual moisture by pressing the coconut rasps within a temperature range between 40° C. and 60° C.;
pulverizing the low-fat pressed cake to particle sizes of less than 150 μm at a maximum pulverization temperature of 80° C.;
fermenting the pulverized pressed cake by mashing the pulverized pressed cake with water to create a pumpable pulp, to which is added an enzyme preparation composed of various types of enzymes; and
isolating coconut meal by means of homogenization, pasteurization and spray drying of the mash fermented with enzymes and further processing into vegetable products.

2. A process in accordance with claim 1, wherein the mashing is carried out by stirring in five parts water to one part pressed cake.

3. A production process in accordance with claim 1, wherein the enzyme types of the enzyme preparations consist of a mixture of cellulase, beta-glucanase and hemicellulase preparations.

4. A production process in accordance with claim 1, further comprising setting optimal fermentation conditions by means of controlling the time and temperature effects as well as the degree of acidity of the mash, whereby the fermentation time runs for 12 hours at a temperature of 42° C. and the initial degree of acidity of the mash is lowered from ca. pH 6.5 to pH 4.0-5.5.

5. A production process in accordance with claim 4, wherein lowering of the degree of acidity of the mash includes adding mono- and disaccharides (sugar) or by adding citric acid.

6. A production process in accordance with claim 1, wherein the homogenization of the fermented acid takes place at a pressure of 200-300 bar and the spray drying takes place according to the vacuum spray drying process.

7. A process for producing vegetable foods from coconuts, the process comprising the following process steps:
isolating coconut rasps from coconut meat;
pressing the coconut rasps within a temperature range between 40° C. and 60° C. to isolate coconut oil and a low-fat pressed cake;
pulverizing the low-fat pressed cake to particle sizes of less than 150 μm at a maximum pulverization temperature of 80° C.;
fermenting the pulverized pressed cake by mashing the pulverized pressed cake with water to create a pumpable pulp, to which is added an enzyme preparation composed of an enzyme or various types of enzymes;
isolating coconut meal from the mash fermented with enzymes.

8. A process in accordance with claim 7, wherein said step of isolating coconut meal from the mash fermented with enzymes includes homogenization, pasteurization and spray drying of the mash fermented with enzymes.

9. A process in accordance with claim 8, further comprising processing the isolated coconut meal to provide a vegetable product.

10. A process in accordance with claim 7, wherein said step of isolating coconut rasps from coconut meat comprises removing coconut meat from the coconut shell and drying the removed coconut meat at less than 100° C.

11. A process in accordance with claim 7, wherein said low-fat pressed cake has residual moisture content of about 5%.

12. A process in accordance with claim 7, wherein the mashing is carried out by stirring in five parts water to one part pressed cake.

13. A production process in accordance with claim 7, wherein the enzyme types of the enzyme preparations consist of a mixture of cellulase, beta-glucanase and hemicellulase preparations.

14. A production process in accordance with claim 7, further comprising setting optimal fermentation conditions by means of controlling the time and temperature effects as well as the degree of acidity of the mash, whereby the fermentation time runs for 12 hours at a temperature of 42° C. and the initial degree of acidity of the mash is lowered from ca. pH 6.5 to pH 4.0-5.5.

15. A production process in accordance with claim 11, wherein lowering of the degree of acidity of the mash includes adding mono- and disaccharides (sugar) or by adding citric acid.

16. A production process in accordance with claim 7, wherein the homogenization of the fermented acid takes place at a pressure of 200-300 bar and the spray drying takes place according to the vacuum spray drying process.
